(19) United States
(12) Patent Application Publication
(10) Pub. No.: US 2005/0193949 A1
(43) Pub. Date: Sep. 8, 2005

(54) Method for manufacturing integrated circuits and corresponding device

(75) Inventor: Laurent Paisant, Saint Mars De Desert (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Atmel Nantes SA, Nantes Cedex 3 (FR)

(21) Appl. No.: 11/061,081

(22) Filed: Feb. 18, 2005

(30) Foreign Application Priority Data
Feb. 18, 2004 (FR) 04/01641

(51) Int. Cl. B08B 6/00

(52) U.S. Cl. 118/723 R; 134/1.1

(57) ABSTRACT

A method of manufacturing integrated circuits is provided. The method includes: conditioning of a depositing chamber; introducing of at least a substrate in said depositing chamber; depositing of a compound that does not contain oxygen on said substrate(s); removing of said substrate(s) from said depositing chamber; and cleaning of said chamber with a cleaning plasma. According to an embodiment of the invention, the conditioning step implements a depositing of a conditioning compound containing at least one oxygen atom, so as to react with at least one internal wall of said chamber in order to create a protective layer on the latter.

### CROSS-REFERENCE TO RELATED APPLICATION

The present application claims priority of French Application No. FR 04/01641, filed Feb. 18, 2004, not in English.

### FIELD OF THE INVENTION

The field of the invention is that of integrated circuits and more precisely the manufacturing of integrated circuits.

### BACKGROUND OF THE INVENTION

Integrated circuits consist of a vast number of transistors and other electronic components grouped together on a reduced surface. The gaps between the different elements constituting the circuits are so small that structures allowing to isolate them are necessary, so as to avoid the effects of interference.

The methods for manufacturing integrated circuits thus implement a number of precise technological steps including isolation steps through the creating of inter-metallic dielectric layers, as well as final encapsulation layers. The initial element, which is the substrate, is composed of a well defined material, such as, for example, Si, Ge, GaAs or InP. Thin layers of film made of specific materials are deposited on the surface of these substrates. Once deposited, the film can be subjected to thermal treatment or even photolithography and/or engraving. Some of these steps can be repeatedly implemented in the manufacturing methods.

One of the techniques used to deposit thin layers of film is notably chemical vapor deposition (CVD) and more precisely Plasma Enhanced Chemical Vapor Deposition (PECVD).

The method of manufacturing provides for the deposition of different compounds, notably silicon nitride, on the surface of the substrate.

The PECVD principle is the generating of a plasma from a mix of gases and an electric field. The ions in the plasma collide with the other molecules of the gases (containing, for example, SiH₄ and NH₃) and generate their partial decomposition. This partial disassociation creates radical reactants (for example SiHₓ or NH) which react together on the surface of the substrate to create, for example, a stable SiₓN_{y} chain. This chain will form the thin layer of Si₃N₄.

Known PECVD equipment which allows to deposit these films in thin layers comprises a PECVD reaction vessel bearing a deposition chamber whose walls are made in aluminium and in which the vacuum is created. The depositing chamber is then filled with a compressed gas reduced and subjected to an electric field.

The PECVD equipment implements a sequence of operations, called “alpha sequence”, split up into the following sequence of steps:
a conditioning step with a compound X of the depositing chamber;
an introducing step of a substrate (also called “plate”) in the depositing chamber;
a depositing step of a thin layer of the same compound X on the substrate (also called passivating layer);
a removing step of the substrate from the chamber;
a cleaning step using a cleaning plasma of the depositing chamber.

According to the techniques of the prior art, the compound used in the conditioning of the depositing chamber is the same as that deposited on the surface of the substrate. This is viewed as necessary, notably so as to avoid the risk of contaminating the chamber.

In the event of deposits of thin layers of Si₃N₄ (silicon nitride), more precisely, the conditioning of the chamber is done using silicon nitride.

In the methods of manufacturing integrated circuits, the conditioning and cleaning steps of the depositing chamber are vital in order to obtain a reproducible PECVD sequence as regards the characteristics of the deposits made on the substrates.

Indeed, the conditioning of the chamber prior to deposition allows to ensure a reproducible surface state of the chamber and of the substrate plate—or plate (or wafer)—, this surface state controlling, among other things, the thermal conductivity and impedance of the depositing chamber.

The cleaning step of the chamber at the end of each deposition sequence also allows to ensure the stability of the method. The plasmas used for cleaning are optimised according to the materials deposited on the surface of the substrate, and in relation to the deposition speed, the risks of density defects and the mechanical constraints in the generated films.

The plasmas used for cleaning are usually fluorine based, comprising, for example, carbon tetrafluorid (CF₄). A major inconvenience of this technique of the prior art is the presence of a parasite (or interference) deposit of AlF₃. This deposit is due to a reaction of the aluminium present in the material constituting the walls of the reaction vessel and the fluorine of the cleaning plasma, this parasite deposit builds up in the depositing chamber in line with the advancement of the implementation of the cycles described by the “alpha sequence”.

Thus, one of the inconveniences of this technique is that it does not allow reproducible deposits to be obtained from one substrate to the other. Indeed, the presence of this parasite deposit notably modifies the surface state of the depositing chamber.

Another inconvenience of this technique is that the parts of the reaction vessel, deteriorated by this parasite deposit, need to be frequently changed and consequently implies maintenance costs and a lot of equipment.

Another inconvenience of this technique is that the efficiency of the PECVD equipment is not optimised.

### SUMMARY OF THE INVENTION

An embodiment of the invention notably has the aim of overcoming these inconveniences of the prior art.

More precisely, an aim of an embodiment of the invention is to propose a technique allowing to avoid the build up of a parasite deposit in the reaction chamber.

Another aim of an embodiment of the invention is to propose a technique allowing the deposition of thin layers of a compound on a substrate in a reproducible manner.

Yet another aim of an embodiment of the invention is to allow efficient and reproducible depositing (in particular regarding mechanical constraints) whilst reducing the costs linked to the maintenance of the PECVD equipment.

These aims, as well as others which will emerge later, are reached using a method of manufacturing integrated circuits comprising the following steps:
conditioning of a depositing chamber;
introducing of at least a substrate in said depositing chamber;
depositing of a compound that does not contain oxygen on said substrate(s);
removing of said substrate(s) from said depositing chamber;
cleaning of said chamber with a cleaning plasma.

According to an embodiment of the invention, said conditioning step implements a depositing of a conditioning compound, containing at least one oxygen atom, so that said compound react with at least one internal wall of said chamber in order to create a protective layer on the latter, said protective layer allowing to avoid the build-up of a parasite deposit in the chamber.

Thus, an embodiment of the invention is based on an entirely new and inventive approach consisting in using a compound containing oxygen to condition the depositing chamber in the methods of depositing compounds that do not contain oxygen, so as to create, through the reaction with the material with which the walls of the depositing chamber are made, a protective layer.

Indeed, the applicant surprisingly discovered that the implementing of such a method allows to avoid the build up of parasite deposits due to a reaction between the cleaning plasma and the walls of the depositing chamber, thanks to the formation of a protective layer on the surface of the walls of the depositing chamber during the conditioning step.

Moreover, the applicant surprisingly noticed that in using a compound different to that intended to be deposited on the substrates to condition the chamber does not contaminate the latter (probably as long as it reacts with the walls of the chamber).

Advantageously, at least one of the walls of the depositing chamber comprise aluminium and/or an aluminium alloy and said cleaning means are a cleaning plasma comprising a fluorinated compound.

Preferably, the fluorinated compound is tetrafluoromethane (CF₄).

Preferably, the substrates, on which the deposits are made, are a plate of a compound chosen from among Si, Ge, GaAs and InP.

Advantageously, the conditioning compound implemented to condition the chamber is silicon dioxide (SiO₂).

Thus, during conditioning, this compound reacts with the aluminium in the walls of the depositing chamber to create aluminium oxide (Al₂O₃). The walls of the chamber are thus covered with a protective layer of aluminium oxide and consequently, during the cleaning of the chamber with fluorinated cleaning plasma, no parasite deposit of AlF₃ is created.

Indeed, on the one hand, the fluorine almost does not react with the surface layer of alumina because it is very difficult for the fluorine atoms to take the place of the oxygen atoms in alumina. In addition, the fluorine atoms cannot penetrate and cross the layer of alumina in order to reach the room walls aluminium because the layer of alumina is fluorine tight.

Preferably, the silicon dioxide is made from a mix of silane (SiH₄) and dinitrogen oxide (N₂O). The dinitrogen oxide can also be replaced with oxygen (O₂).

Advantageously, the mix is made from a flow of silane (SiH₄) with a flow rate of 110 sccm and a flow of dinitrogen oxide (N₂O) with a flow rate of 2000 sccm.

Advantageously, the gas mix further comprises nitrogen (N₂) as carrier gas.

Preferably, said chamber is subjected to a 400 W electric field during the conditioning step.

Advantageously, said conditioning step is performed with a depositing pressure of 330 mT for a duration of 10 s.

Advantageously, the compound that does not contain any oxygen and which is deposited on the substrate(s) is the silicon nitride (Si₃N₄).

An embodiment of the invention also relates to a device allowing to implement such a method and comprising at least one means of routing said conditioning compound containing oxygen in said depositing chamber.

Other characteristics and advantages will become clearer upon reading the following description of an embodiment, given by way of a non-restrictive example, in reference to the attached drawings.

### BRIEF DESCRIPTION OF THE DRAWINGS

FIG. 1 illustrates a synoptic of the method of manufacturing an integrated circuit according to an embodiment of the invention;

FIGS. 2a, 2b, 2c and 2d illustrate the different steps implemented by the manufacturing method in FIG. 1;

FIG. 3 describes the development of the depositing speed of Si₃N₄ depending on the number of substrates processed according to the technique of the prior art and according to an embodiment of the invention; and

FIG. 4 describes the development of the mechanical constraint (or stress) of the layers of Si₃N₄ created on the substrates according to the technique of the prior art and according to an embodiment of the invention, according to the number of processed substrates.

### DETAILED DESCRIPTION OF ILLUSTRATIVE EMBODIMENTS

The overall principle of an embodiment of the invention is based on the conditioning of the depositing chamber of a PECVD equipment with a compound containing oxygen, prior to the depositing of a compound that does not contain oxygen on a substrate.

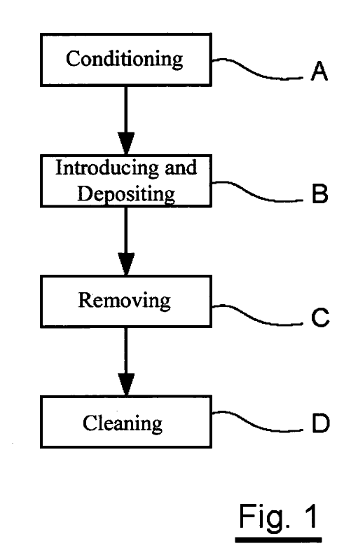

Presented below, in relation to FIG. 1, are the different steps implemented according to the embodiment of an embodiment of the invention:
1^{st} conditioning step A of the depositing chamber, also called pre-depositing stage, with a compound containing oxygen, such as silicon dioxide (SiO₂);
2^{nd} introducing step of a substrate—or plate—, for example of silicon, to be processed and depositing step B on the latter of a layer of a compound that does not contain oxygen, such as silicon nitride (Si₃N₄);
3^{rd} removing step C of the then processed plate;
4^{th} cleaning step D of the chamber using a fluorinated cleaning plasma.

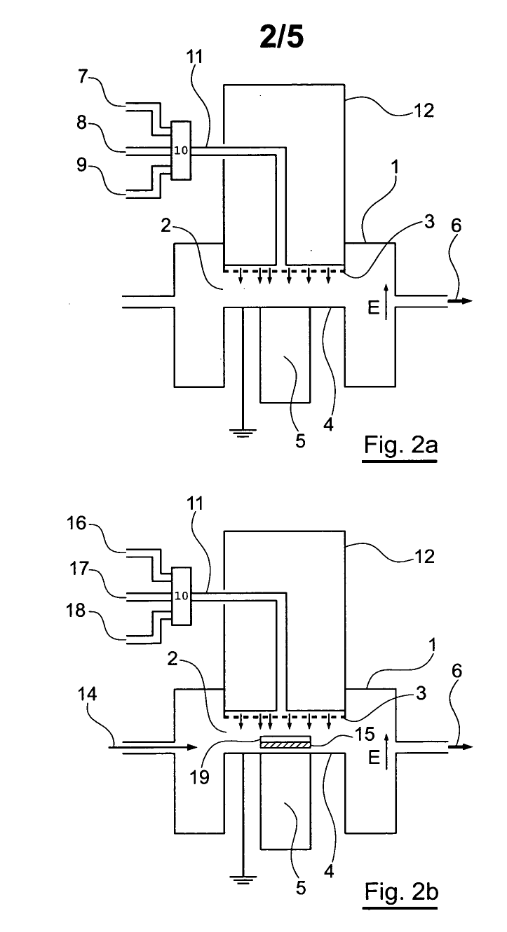

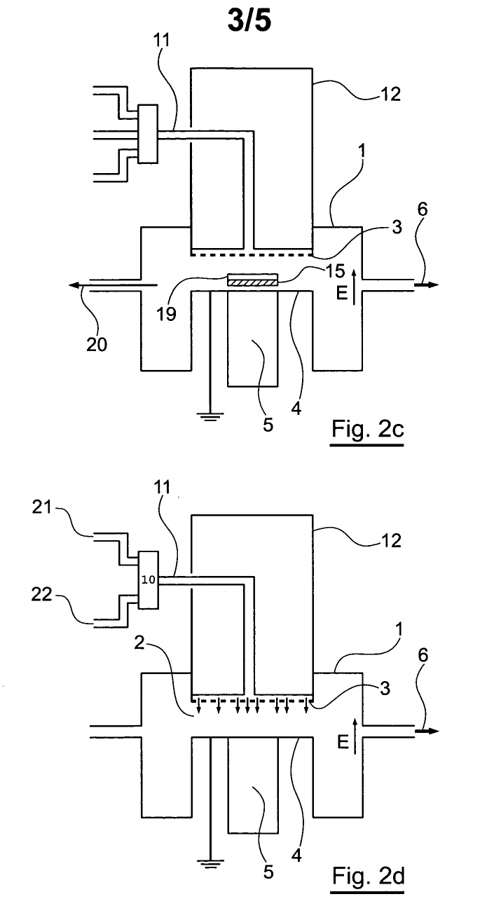

FIGS. 2a, 2b, 2c and 2d respectively describe each of the steps in FIG. 1 in greater detail.

FIG. 2a illustrates the conditioning step A of a PECVD equipment comprising a depositing chamber 1 (also called reaction vessel or reaction chamber) whose internal walls are made in aluminium or an aluminium alloy. The depositing chamber 1 has a plasma zone 2 situated between an upper electrode 3 and a lower electrode 4 connected to the ground, and a radio-frequency source allowing to introduce an electric field E.

During the conditioning step, the electric field E, for example, is about 400 W in power, the lower electrode 4 is about 250° C. and the upper electrode 3 is 300° C. These temperatures of electrodes 3 and 4 can be maintained during the different steps of the method.

The depositing chamber 1 is in vacuum, thanks to the pump connected to the empty chamber at opening 6.

According to this embodiment, the conditioning of the depositing chamber 1 is performed by a pre-depositing of SiO₂. The tubes 7 and 8 respectively allowing the silane (SiH₄) and dinitrogen oxide (N₂O) gases to enter with, for example, respective flow rates of 110 sccm and 2000 sccm. The tube 9 allows a carrier gas such as nitrogen (N₂) to enter if the latter is judged necessary.

The gas mixes in the mixer 10 and the gas mix is routed via a duct 11 to the depositing chamber 1 by passing through a chamber 12, also in vacuum, so as to avoid any reaction between the different gases.

At the inlet to the depositing chamber, a gas diffuser 3 (also constituting the upper electrode) allows to disperse the gas mix evenly throughout the plasma zone 2. The gas molecules then ionise and react to create silicon dioxide on the internal walls of the depositing chamber 1, the silicon dioxide reacting with the aluminium present in the walls to create a protective layer of aluminium oxide (Al₂O₃) on the walls.

The duration of plasma coating during the conditioning step can, for example, be about 10 s and the depositing pressure can be 330 mT.

It can also be envisaged to replace the dinitrogen oxide (N₂O) with oxygen (O₂) in the gas mix to allow the formation of a pre-deposition of SiO₂.

FIG. 2b consecutively illustrates in the conditioning step of the chamber, the introducing step of the substrate to be processes and the depositing step B of the silicon nitride (Si₃N₄). Usually the substrate can be a plate of silicon 15 generally 100 to 300 mm in diameter.

However, it is possible to apply this technique to any substrate, such as, for example, a plate of InP or AsGa.

The plate of silicon 15 is introduced into the depositing chamber 2 according to the arrow 14 and deposited on the support of the hot plate 5. In FIGS. 2a, 2b, 2c and 2d the same numeric references identify the identical elements.

During the depositing stage of a thin layer of silicon nitride (Si₃N₄), the plate support 5 is brought to the same temperature as the lower electrode 4, usually 250° C. The strength of the electric field can be 500 W.

The arrows 16, 17 and 18 respectively indicate the inlets of silane (SiH₄), ammonia (NH₃) and nitrogen (N₂) gases as carrier gases with, for example, respective flow rates of 300 sccm, 700 sccm and 3500 sccm.

The gas mix arrives in the plasma zone at the gas diffuser 13 to create, on the surface of the silicon plate, a deposit of silicon nitride 19. The deposit created on the substrate is also called “passivating layer”.

The thickness of this layer can vary and is usually about 0.85 to 1.1 μm, with a plasma coating duration of about 75 s and a depositing pressure, for example, of 850 mT.

It can also be envisaged that the introducing of the plate to be processed is carried out by means of the plate support, if the latter is vertically movable, for example, or that it is introduced via the inlet 6 through which the vacuum is created.

The next plate to be processes can, moreover, be placed in a chamber adjacent to the depositing chamber 2, in which a partial vacuum can be created, so as not to entire disrupt the vacuum in the depositing chamber when introducing the plate.

FIG. 2c illustrates the removal C, according to the arrow 20, of the then processed silicon plate 15 from the depositing chamber 1.

The depositing chamber 1 is then subjected to a cleaning step D, illustrated in FIG. 2d, using a fluorinated plasma. The gases arriving via the inlets 21 and 22 are respectively tetrafluoromethane (CF₄) and oxygen (O₂) each with, for example, flow rates of 400 sccm.

During the cleaning step, the plasma coating duration can be 75 s with a pressure of 850 mT and an electric field of 850 W, the temperatures of the electrodes 3 and 4 remaining unchanged.

A protective layer of Al₂O₃ having been created on the walls of the depositing chamber 1, during the conditioning of the chamber, means that a parasite deposit of AlF₃ is not created during the cleaning step using fluorinated plasma.

The different arrivals of gas during the different steps can naturally be ensured with different inlets, each of the three different gas mixes thus implemented can be routed down to the depositing chamber 1 in three different ducts. It is also possible to provide a branch line to which these different ducts will be connected on to and provide a single inlet by the gas diffuser 3 and the chamber 1, the branch line being distanced to a greater or lesser extent from the latter.

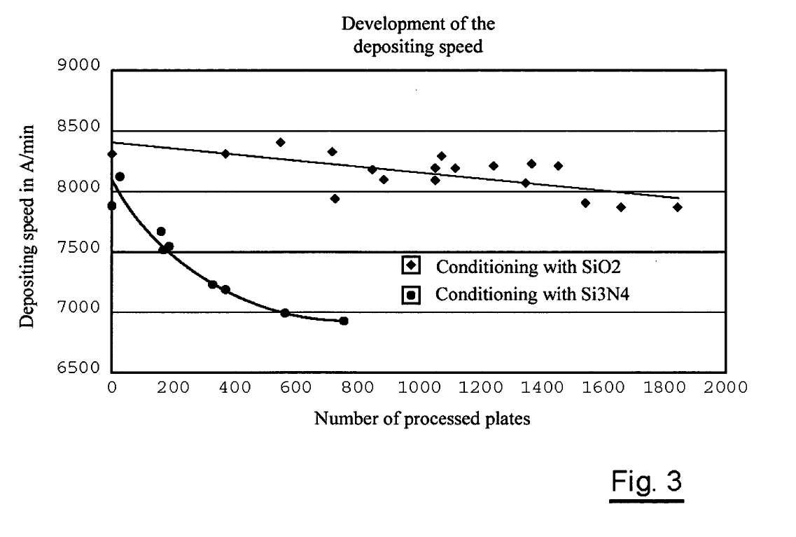

FIG. 3 illustrates the development in the depositing speed of Si₃N₄ depending on the number of plates processed in a PECVD equipment.

A first curve illustrates the development of the depositing speed according to the technical conditions of the prior art, implementing the conditioning of the depositing chamber with Si₃N₄ for the ulterior deposit of the same compound on the plates. The conditioning thus being carried out under the same temperature condition of the electrodes, value of the electric field and of the depositing pressure as for the deposit of Si₃N₄ on the silicon plates, but with a plasma coating duration of 10 s. We notice a rapid decrease in the depositing speed as more plates are being processed.

The other curve summarizes the readings taken according to the conditions of the embodiment described in FIGS. 2a, 2b, 2c and 2d for which the conditioning was done with silicon dioxide.

These readings highlight a much slower reduction in the depositing speed depending on the number of plates processed when the depositing chamber is conditioned with SiO₂ prior to the depositing of Si₃N₄.

The parasite deposit of AlF₃ in the depositing chamber using the techniques of the prior art indeed reduce the depositing speed of Si₃N₄ and implies the replacing of several parts of the chamber, modified by this parasite deposit, after processing but a little more than 700 plates (the chosen threshold being a mechanical constraint greater than or equal to −1.10⁹ dynes/cm²) . When the mechanical constraint exceeds this value, the passivating layer cracks and therefore no longer ensures the protection of the integrated circuits.

In the case of conditioning with silicon dioxide according to an embodiment of the invention, the depositing speed reduces much slower, and more than 2500 plates can be processed before any parts of the reaction vessel need to be replaced.

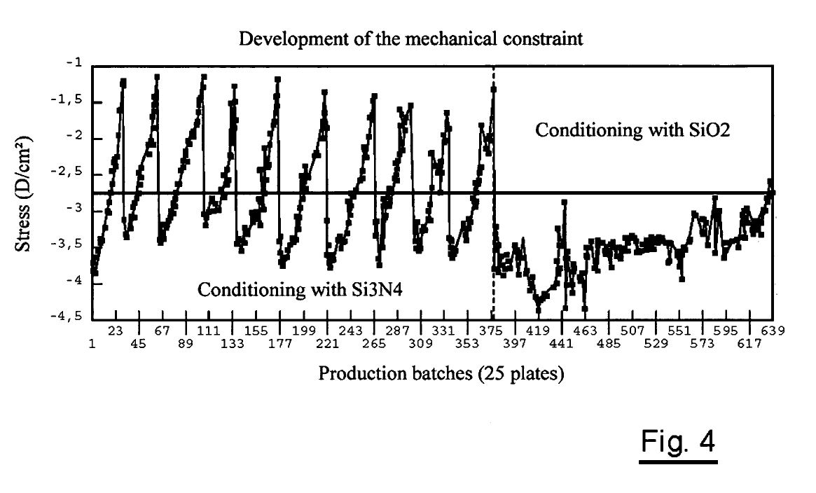

FIG. 4 illustrates the development of the mechanical constraints (or stress) of the layers of Si₃N₄ created depending on the number of batches of plates processed, one batch of plates corresponding to 25 silicon plates simultaneously processed.

The stability and reproducibility of the method of manufacturing is indeed vital in order to obtain integrated circuits that have identical characteristics such as mechanical constraint. The left part of the curve illustrates the processing of silicon plates according to the known technique of the prior art, in which the conditioning of the depositing chamber is performed with the same compound as that intended to be deposited on the plates, that being with silicon nitride Si₃N₄.

The curve here illustrates a rapid variation in the mechanical constraint of the plates processed as the production batches progress, each break in the profile corresponding to a replacement of parts of the reaction vessel deteriorated by the parasite deposit of AlF₃, this replacing taking place after about every 35 batches of plates.

The right part of the curve illustrates the conditioning according to an embodiment of the invention with silicon dioxide, so as to prevent the build up of the parasite deposit of AlF₃, and shows a much slower development in the mechanical constraint of the silicon plates, the parts of the chamber no longer requiring to be changed as frequently.

These results, corroborating with those in FIG. 3, show that an embodiment of the invention thus actually allows to greatly reduce the maintenance costs and the costs associated with the replacing of parts of the reaction vessel, and that it allows to obtain better reproducibility of the method of manufacturing and of the characteristics of the integrated circuits obtained by this method.

An embodiment of the invention thus also allows to reduce the frequency of checks carried out on the produced plates and the cost associated with these checks.

The method, described according to these different embodiments, can also be implemented to simultaneously process several plates of silicon or other material in PECVD equipment intended to receive several plates.

Although the present invention has been described with reference to preferred embodiments, workers skilled in the art will recognize that changes may be made in form and detail without departing from the spirit and scope of the invention.

1. A method of manufacturing integrated circuits comprising the following steps:
conditioning of a depositing chamber;
introducing of at least a substrate in said depositing chamber;
depositing of a compound that does not contain oxygen on said substrate(s);
removing of said substrate(s) from said depositing chamber;
cleaning of said chamber with a cleaning plasma; and
wherein said conditioning step implements a depositing of a conditioning compound, containing at least one oxygen atom, so that said compound react with at least one internal wall of said chamber in order to create a protective layer on the latter, said protective layer allowing to avoid the formation of a parasite deposit in the chamber.

2. The method set forth in claim 1, wherein at least one of the walls of the depositing chamber comprise aluminium and/or an aluminium alloy.

3. The method set forth in claim 1, wherein said cleaning plasma comprises a fluorinated compound.

4. The method set forth in claim 3, wherein said fluorinated compound is tetrafluoromethane.

5. The method set forth in claim 1, wherein at least one of said substrates is a plate of a compound chosen from among Si, Ge, GaAs and InP.

6. The method set forth in claim 1, wherein said conditioning compound is silicon dioxide.

7. The method set forth in claim 6, wherein said silicon dioxide is made from a mix of silane and dinitrogen oxide or oxygen.

8. The method set forth in claim 7, wherein said mix is made from a flow of silane with a flow rate of 110 sccm and a flow of dinitrogen oxide with a flow rate of 2000 sccm.

9. The method set forth in claim 7, wherein said gas mix further comprises nitrogen.

10. The method set forth in claim 1, wherein during the conditioning step, said chamber is subjected to a 400 W electric field.

11. The method set forth in claim 1, wherein the conditioning step is performed with a depositing pressure of 330 mT.

12. The method set forth in claim 1, wherein said conditioning step last for practically 10 s.

13. The method set forth in claim 1, wherein said compound deposited on said substrate(s) is the silicon nitride.

14. Device for manufacturing integrated circuits comprising:
a depositing chamber provided to receive at least one substrate;
means for conditioning said depositing chamber;
means for depositing at least one layer of a compound that does not contain oxygen on said substrate;
means for cleaning said depositing chamber using a cleaning plasma once said substrate has been removed; and
at least one means of routing in said depositing chamber of a conditioning compound containing at least one oxygen atom, so that said compound react with at least one internal wall of said chamber in order to create a protective layer on the latter, said protective layer allowing to avoid the formation of a parasite deposit in the chamber.
